(19) United States
(12) Patent Application Publication
(10) Pub. No.: US 2015/0003253 A1
(43) Pub. Date: Jan. 1, 2015

(54) METHOD AND APPARATUS FOR OFFLOADING TRAFFIC

(71) Applicant: NOKIA SOLUTIONS AND NETWORKS OY, Espoo (FI)

(72) Inventors: Gyorgy Tamas WOLFNER, Budapest (HU); Janne Petteri TERVONEN, Espoo (FI); Hanns Juergen SCHWARZBAUER, Grobenzell (DE); Simone REDANA, Munich (DE)

(21) Appl. No.: 14/318,028

(22) Filed: Jun. 27, 2014

Related U.S. Application Data
(60) Provisional application No. 61/840,977, filed on Jun. 28, 2013.

(51) Int. Cl. H04W 28/08

(52) U.S. Cl. CPC H04W 28/08
USPC 370/237

(57) ABSTRACT

A method and apparatus may be configured to receive, by a user equipment, offloading assistance information from a network element of a first network. The method may also comprise receiving, by the user equipment, at least one offloading related policy for offloading traffic to at least one second network. The offloading related policy may comprise a policy validity criterion that takes the offloading assistance information into account. The method may also comprise applying the offloading related policy in the user equipment if the policy validity criterion is met.

### BACKGROUND

1. Field

Embodiments of the invention relate to offloading of traffic by a user equipment from a first network to a second network.

2. Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

Traffic offloading in the telecommunication field generally relates to using complementary network technologies to transmit communication that was planned to be transmitted by a first network.

### SUMMARY

According to a first embodiment, a method may include receiving, by a user equipment, offloading assistance information from a network element of a first network. The method can include receiving, by the user equipment, at least one offloading related policy for offloading traffic to at least one second network. The offloading related policy includes a policy validity criterion that takes the offloading assistance information into account. The method can also include applying the offloading related policy in the user equipment if the policy validity criterion is met.

In the method of the first embodiment, the offloading assistance information may include at least one of load information of the first network and an indication of whether a load of the first network is high, normal, or low.

In the method of the first embodiment, the offloading related policy may include identification information of the at least one second network and related offloading priority information.

In the method of the first embodiment, at least two offloading related policies may be received and only one of the received offloading related policies may be applied at a time.

In the method of the first embodiment, the network element of the first network may be a base station.

In the method of the first embodiment, the offloading related policy for offloading traffic from the first network to the at least one second network may be received from a server.

In the method of the first embodiment, the first network may be an access network and the second network may be a Wireless Local Area Network.

According to a second embodiment, an apparatus includes at least one processor and at least one memory including computer program code. The at least one memory and the computer program code are configured to, with the at least one processor, cause the apparatus at least to receive offloading assistance information from a network element of a first network. The apparatus may also receive at least one offloading related policy for offloading traffic to at least one second network. The offloading related policy includes a policy validity criterion that takes the offloading assistance information into account. The apparatus may also apply the offloading related policy in the apparatus if the policy validity criterion is met.

In the apparatus of the second embodiment, the offloading assistance information may include at least one of load information of the first network, and an indication of whether a load of the first network is high, normal, or low.

In the apparatus of the second embodiment, the offloading related policy may include identification information of the at least one second network and related offloading priority information.

In the apparatus of the second embodiment, at least two offloading related policies may be received and wherein only one of the received offloading related policies may be applied at a time.

In the apparatus of the second embodiment, the network element of the first network may be a base station.

In the apparatus of the second embodiment, the offloading related policy for offloading traffic from the first network to the at least one second network may be received from a server.

In the apparatus of the second embodiment, the first network may be an access network and the second network may be a Wireless Local Area Network.

In the apparatus of the second embodiment, the apparatus may be a user equipment.

According to the third embodiment, a computer program product can be embodied on a non-transitory computer readable medium. The computer program product can be configured to control a processor to perform a process according to the first embodiment.

According to a fourth embodiment, a method can include transmitting, by a network element, a policy for offloading traffic from a first network to at least one second network to a user equipment. The policy for offloading traffic includes a policy validity criterion taking offloading assistance information from the first network into account.

In the method of the fourth embodiment, the offloading related policy may include identification information of the at least one second network and related offloading priority information.

In the method of the fourth embodiment, the transmitting may include transmitting at least two policies for offloading traffic. The policy validity criterion of each policy may be exclusive and may allow the applying of only one policy at a time.

In the method of the fourth embodiment, the network element may include a server.

In the method of the fourth embodiment, the first network may be an access network and the second network may be a Wireless Local Area Network.

According to a fifth embodiment, an apparatus can include at least one processor and at least one memory comprising computer program code, the at least one memory and the computer program code are configured to, with the at least one processor, cause the apparatus at least to transmit a policy for offloading traffic from a first network to at least one second network to a user equipment. The policy for offloading traffic includes a policy validity criterion taking offloading assistance information from the first network into account.

In the apparatus of the fifth embodiment, the offloading related policy may include identification information of the at least one second network and related offloading priority information.

In the apparatus of the fifth embodiment, the at least one memory and the computer program code are further configured to cause the apparatus to transmit at least two policies for offloading traffic. The policy validity criterion of each policy may be exclusive and may allow the applying of only one policy at a time.

In the apparatus of the fifth embodiment, the apparatus may include a server.

In the apparatus of the fifth embodiment, the first network may be an access network and the second network may be a Wireless Local Area Network.

According to a sixth embodiment, a computer program product can be embodied on a non-transitory computer readable medium. The computer program product can be configured to control a processor to perform a process according to the fourth embodiment.

### BRIEF DESCRIPTION OF THE DRAWINGS

For proper understanding of the invention, reference should be made to the accompanying drawings, wherein:

FIG. 1 illustrates a logic flow diagram of a method according to embodiments of the invention.

FIG. 2 illustrates a logic flow diagram of a method according to embodiments of the invention.

FIG. 3 illustrates an apparatus according to embodiments of the invention.

FIG. 4 illustrates an apparatus according to embodiments of the invention.

FIG. 5 illustrates an apparatus according to embodiments of the invention.

FIG. 6 illustrates a system of apparatuses according to embodiments of the invention.

### DETAILED DESCRIPTION

Certain embodiments of the present invention relate to using offload indications in conjunction with user-equipment policies.

The Third Generation Partnership Project (3GPP) Radio Layer 2 (RAN2) working group is studying different aspects of 3GPP Wi-Fi technologies. More specifically, one area of study relates to methods of steering communication of user equipment (UEs) towards wireless local-area networks (WLANs) in the event of 3GPP Radio-Access Network (RAN) overload. Examples of user equipment may comprise, but are not limited to, a mobile device, handset, mobile phone, personal-digital assistant, smart phone, or other personal electronic/computing device. By steering UEs toward WLANs in the event of 3GPP RAN overload, the traffic corresponding to the steered UEs can be offloaded from the 3GPP RAN onto the WLANs, i.e., the traffic of the steered UEs is transferred via WLANs instead of 3GPP RAN. Some results of the conducted studies have been documented in 3GPP Technical Report (TR) 37.834 version 0.3.0.

An Access Network Discovery and Selection Function (ANDSF) has been specified within 3GPP Technical Specification (TS) 23.402 version 12.1. ANDSF can provide policies to UEs regarding when the UEs are to use accessible WLANs, and which WLANs are preferable for use by the UEs. In the future, 3GPP RAN2 may further define how 3GPP-WiFi interworking will be implemented when ANDSF policies are available (and used) by the UE.

As described above, an ANDSF server may provide policies to UEs. However, an ANDSF server generally may be not suitable to dynamically provide policy-updates to the UEs. In other words, the policies used by UEs generally may not be immediately updated, such as at a time that a RAN overload occurs.

In the currently proposed approaches, assistant information may be sent to the UEs to allow the UEs to properly respond to a RAN overload. For example, according to Solution 2 described within Section 6.1.2 of TR 37.834 (version 0.3.0), assistant information provided by a RAN may be used with ANDSF. According to Solution 2, “If the UE utilizes ANDSF policy, the UE Access Stratum may forward the received assistant information to the interworking upper layer of the UE.”

However, Solution 2 provides only a general indication that assistant information provided by a RAN can be used with ANDSF. Solution 2, as described in the current version of the Technical Report, does not describe specifics as to how the assistant information may be used with ANDSF.

In another previous approach, according to Hotspot 2.0 specifications determined by the Wi-Fi Alliance, specifications of Hotspot 2.0 may help UEs to perform WLAN network discovery and selection. One example of information that UEs can use to perform WLAN network selection is WLAN load information. As an example of WLAN load information, a threshold may be given in the Hotspot 2.0 policies to indicate to WLAN hosts when a WLAN, identified by the policies, may be selected.

In view of the above difficulties, and in contrast with the previous approaches, embodiments of the present invention may be used in conjunction with UEs that have policies for traffic routing and that receive offloading assistance information. For example, certain embodiments may be directed to UEs that have ANDSF Inter-System Routing Policies (ISRPs) policies for traffic routing, and the UEs may receive WLAN offloading assistance information. The UEs may receive WLAN offloading assistance information from 3GPP RAN base stations, i.e., eNode Bs. In certain embodiments, policies can be determined by an ANDSF server. In other embodiments, policies can be provided by a network operator and then transmitted by the ANDSF server to UEs.

In certain embodiments of the invention, ANDSF Inter-System Routing Policy (ISRP) flow distribution rules may further comprise a new type of validity condition that may be related to the values contained within WLAN offloading assistance information received by the UE (from the 3GPP RAN). In other words, the ANDSF ISRPs may refer to values contained within the WLAN offloading assistance information, and may direct the UE according to the policies and the received WLAN offloading assistance information.

If the WLAN offloading assistance information may comprise a load condition for the 3GPP RAN load (corresponding to the amount of traffic that may be transmitted by the currently serving 3GPP RAN node), the new validity conditions may determine which ISRP flow distribution rule is applicable for a specific 3GPP RAN load condition, as described in more detail below.

As such, an operator may define a multiplicity of ISRP flow distribution rules which may give different priorities to the 3GPP RAN networks and to the WLAN access networks whose validity condition may be used to select a specific ISRP flow distribution rule then dependent on the 3GPP RAN load and other parameters provided by the 3GPP RAN. Therefore, the different ISRP rules and their flow distribution rule may be defined well in advance without need to frequently update the ANDSF policies, and the actual ISRP and flow distribution rule selected by the UE may be dynamically adapted to the load condition of the 3GPP RAN.

Each ISRP flow distribution rule may comprise traffic identification, validity conditions, and/or a prioritized list of accesses. Traffic identification may comprise IP filters, Fully Qualified Domain Names (FQDN) may describe the service, or operating system-specific unique application identifier. Validity conditions may be based on a time of day and/or a location. The above-described new validity condition may take into account RAN info/load status.

ISRP validity conditions may comprise public land mobile network (PLMN) and roaming status. In other words, the validity of a certain ISRP rule may be evaluated based on the registered PLMN of the UE, and whether the UE is roaming or not. Within an ISRP rule, there may be multiple flow distribution rules, that each may have separate validity conditions. A flow-distribution-rule validity condition may then take into account a current time of day and location. Certain embodiments of the invention may add new validity conditions to ISRP flow distribution rules to take into account RAN info/load status.

In certain embodiments, the RAN may provide load information/condition corresponding to one of the following values: “RAN load high”, “RAN load is normal”, and “RAN load is low”, for example. Although the present example comprises three different load conditions, other embodiments may contain more or less load conditions. (e.g. expressing the load in a value or a percentage). In circumstances corresponding to “RAN load high” an operator may generally prefer to offload traffic from the RAN to another access network (such as a WLAN access network). In circumstances corresponding to “RAN load is normal” an operator may generally like to implement normal offloading behavior. For example, the operator may decide to offload the traffic to a WLAN access network, if the WLAN access network belongs to the operator. In circumstances corresponding to “RAN load is low” the operator may generally like to avoid offloading traffic from the RAN.

Further, embodiments of the present invention may use different designations to identify each accessible WLAN. In certain embodiments, the designation “SSID1” may act as an identifier of WLANs of the 3GPP operator, while the designation “SSID2” may act as an identifier of WLANs of a roaming partner of the 3GPP operator. Although “SSID1” and “SSID2” are specifically mentioned, these designations are merely exemplary designations. In fact, any type of WLAN identifier that is allowed by current or future ANDSF specifications, also other than SSIDs, may be used to identify accessible WLANs.

In certain embodiments, an operator may configure a UE to operate based on the amount of traffic load that is on a RAN. ISRPs may enable operators to define different priorities of access networks that depend on the traffic type. A filter rule may define that WLANs are preferred over 3GPP RAN for HTTP traffic, while another rule may define that in case of traffic related to an operator service (e.g., Voice over IP service) 3GPP RAN is preferred over WLANs. Specifically, IP level filters or other filter types that are supported by current or future ANDSF specifications may be used. As a first example of UE operation, when the 3GPP RAN is overloaded, then UEs may use any WLAN (either of SSID1 and SSID2, for example) to offload traffic, if WLANs are available. In one embodiment, WLANs identified by SSID1 may be assigned a higher priority for offloading onto as compared to WLANs identified by SSID2.

As a second example of UE operation, when the 3GPP RAN is encountering normal traffic loads, the UE may offload traffic to the operator's WLAN (SSID1) from 3GPP RAN, if the operator's WLAN is available.

As a third example of UE operation, when the 3GPP RAN is encountering low traffic loads, the UE may prefer 3GPP RAN over any WLAN.

In order to enable the UEs to achieve the above-described operation, certain embodiments of the present invention may implement the functionality of the following pseudo-code within the policies provided to the UE.

IF <“RAN load high (offload)”> THEN
SSID1 = priority 1
SSID2 = priority 2
3GPP RAN = priority 3
IF <“ RAN load is normal (normal offloading behavior)”> THEN
SSID1 = priority 1
3GPP RAN = priority 2
SSID2 = priority 3
IF <“ RAN load is low (avoid offloading)”> THEN
3GPP RAN = priority 1
SSID1 = priority 2
SSID2 = priority 3

As described above, in certain embodiments, the 3GPP RAN may provide a RAN load indication (or WLAN offload indication) to the 3GPP UE. However, other embodiments may also utilize assistance information that is more complex than the information provided by the RAN.

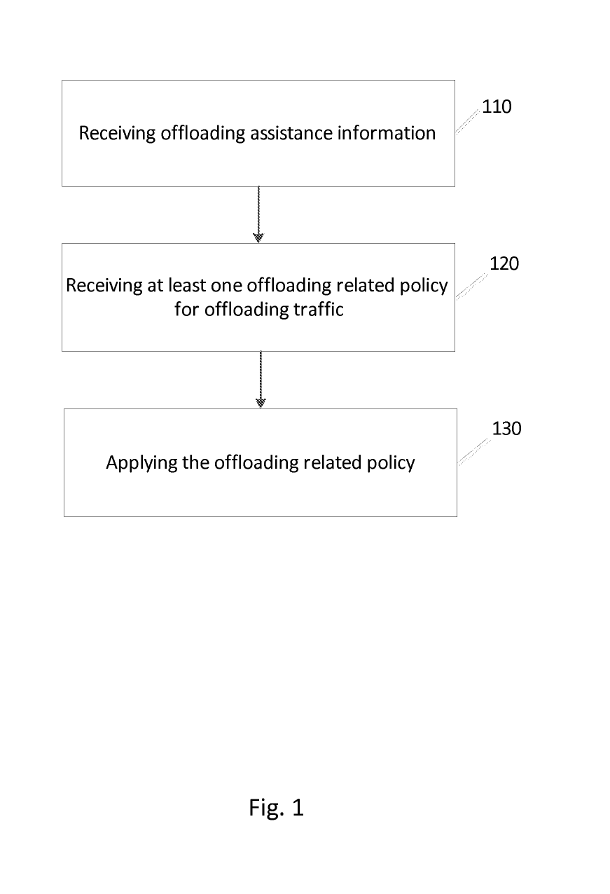

FIG. 1 illustrates a logic flow diagram of a method according to certain embodiments of the invention. The method in FIG. 1 comprises, at 110, receiving, by a user equipment, offloading assistance information from a network element of a first network. The method also comprises, at 120, receiving, by the user equipment, at least one offloading related policy for offloading traffic to at least one second network. The offloading related policy comprises a policy validity criterion that takes the offloading assistance information into account. The method comprises, at 130, applying the offloading related policy in the user equipment if the policy validity criterion is met.

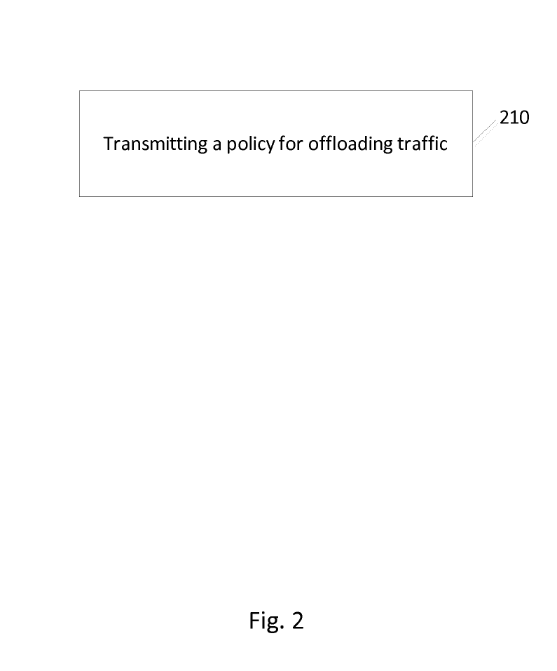

FIG. 2 illustrates a logic flow diagram of a method according to certain embodiments of the invention. The method illustrated in FIG. 2 comprises, at 210, transmitting, by a network element, a policy for offloading traffic from a first network to at least one second network to a user equipment. The policy for offloading traffic comprises a policy validity criterion taking offloading assistance information from the first network into account. The first network may be any type of access network. In certain embodiments, the first network may be a 3GPP radio access network.

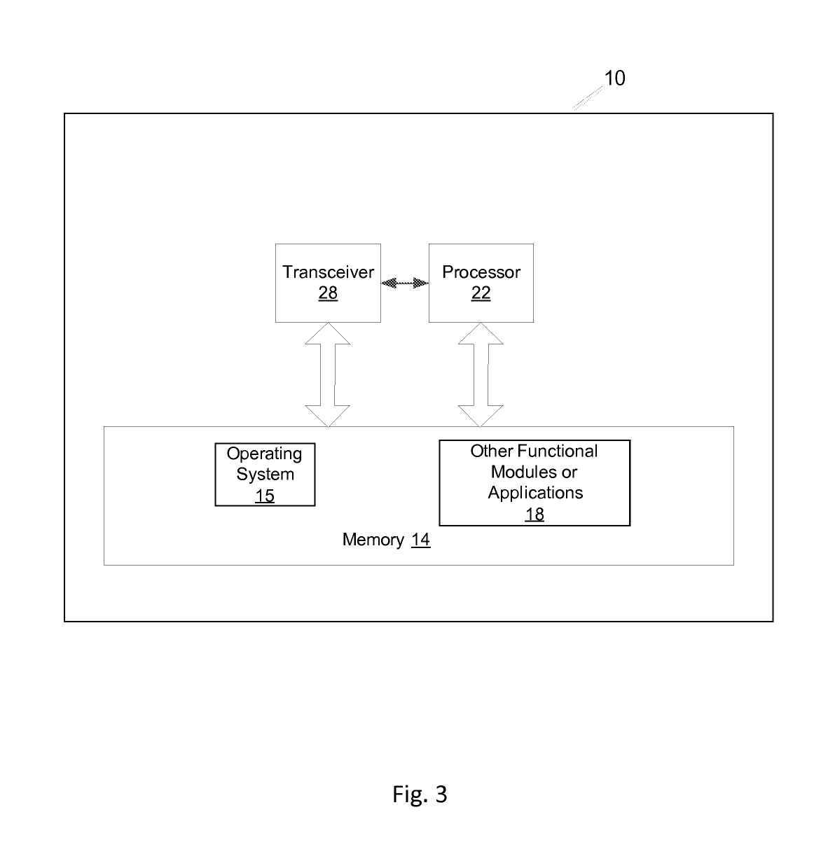

FIG. 3 illustrates an apparatus 10 according to embodiments of the invention. Apparatus 10 may be a receiving device, such as a UE, for example. In other embodiments, apparatus 10 may be a server or any other network node, for example.

Apparatus 10 may comprise a processor 22 for processing information and executing instructions or operations. Processor 22 may be any type of general or specific purpose processor. While a single processor 22 is shown in FIG. 3, multiple processors may be utilized according to other embodiments. Processor 22 may also comprise one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further include a memory 14, coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 may be comprised of any combination of random access memory (RAM), read only memory (ROM), static storage such as a magnetic or optical disk, or any other type of non-transitory machine or computer readable media. The instructions stored in memory 14 may comprise program instructions or computer program code that, when executed by processor 22, enable the apparatus 10 to perform tasks as described herein.

Apparatus 10 may also comprise one or more antennas (not shown) for transmitting and receiving signals and/or data to and from apparatus 10. Apparatus 10 may further comprise a transceiver 28 that modulates information on to a carrier waveform for transmission by the antenna(s) and demodulates information received via the antenna(s) for further processing by other elements of apparatus 10.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In certain embodiments, memory 14 may store software modules that provide functionality when executed by processor 22. The modules may comprise an operating system 15 that provides operating system functionality for apparatus 10. The memory may also store one or more functional modules 18, such as an application or program, to provide additional functionality for apparatus 10. The components of apparatus 10 may be implemented in hardware, or as any suitable combination of hardware and software.

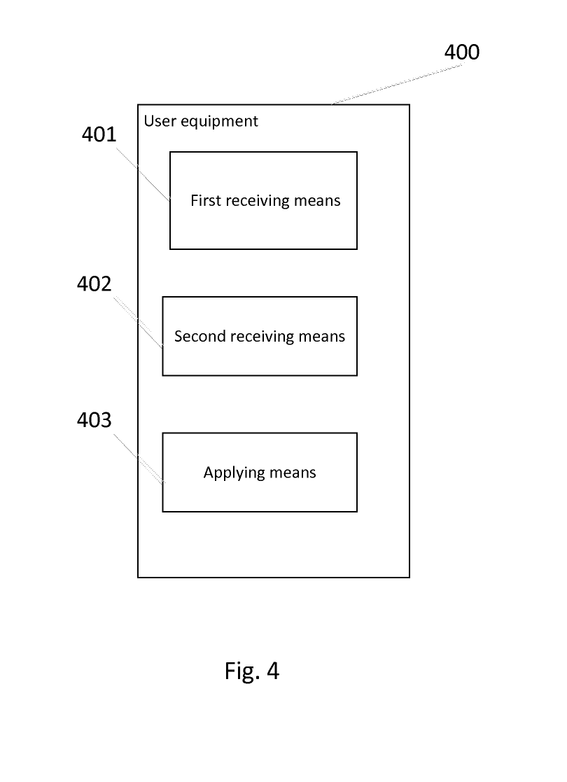

FIG. 4 illustrates an apparatus 400 according to other embodiments of the invention. Apparatus 400 may be, for example, a user equipment. Apparatus 400 may comprise first receiving means 401 for receiving offloading assistance information from a network element of a first network. Apparatus 400 may also comprise second receiving means 402 for receiving at least one offloading related policy for offloading traffic to at least one second network. The offloading related policy may comprise a policy validity criterion that takes the offloading assistance information into account. The apparatus 400 may also comprise an applying means 403 for applying the offloading related policy in the apparatus 400 if the policy validity criterion is met.

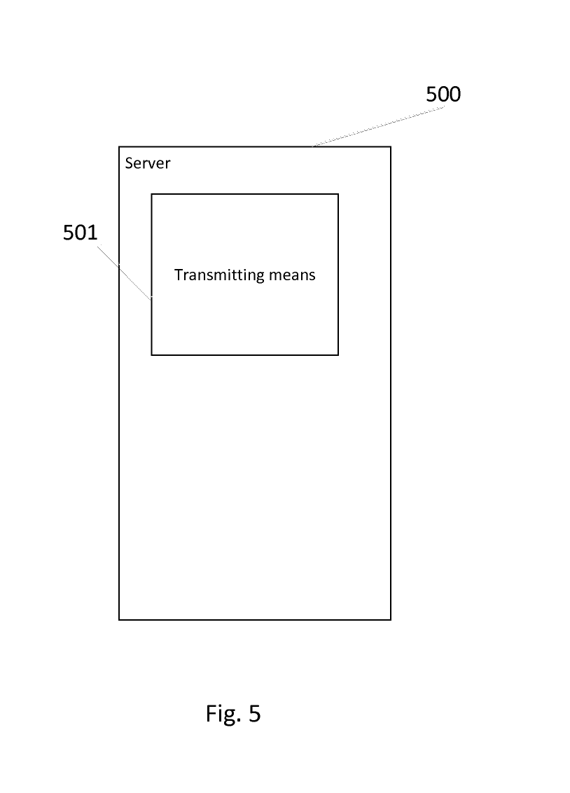

FIG. 5 illustrates an apparatus 500 according to other embodiments of the invention. In certain embodiments, apparatus 500 may correspond to a server. Apparatus 500 may comprise a transmitting means 501 for transmitting a policy for offloading traffic from a first network to at least one second network to a user equipment. The policy for offloading traffic may comprise a policy validity criterion taking offloading assistance information from the first network into account.

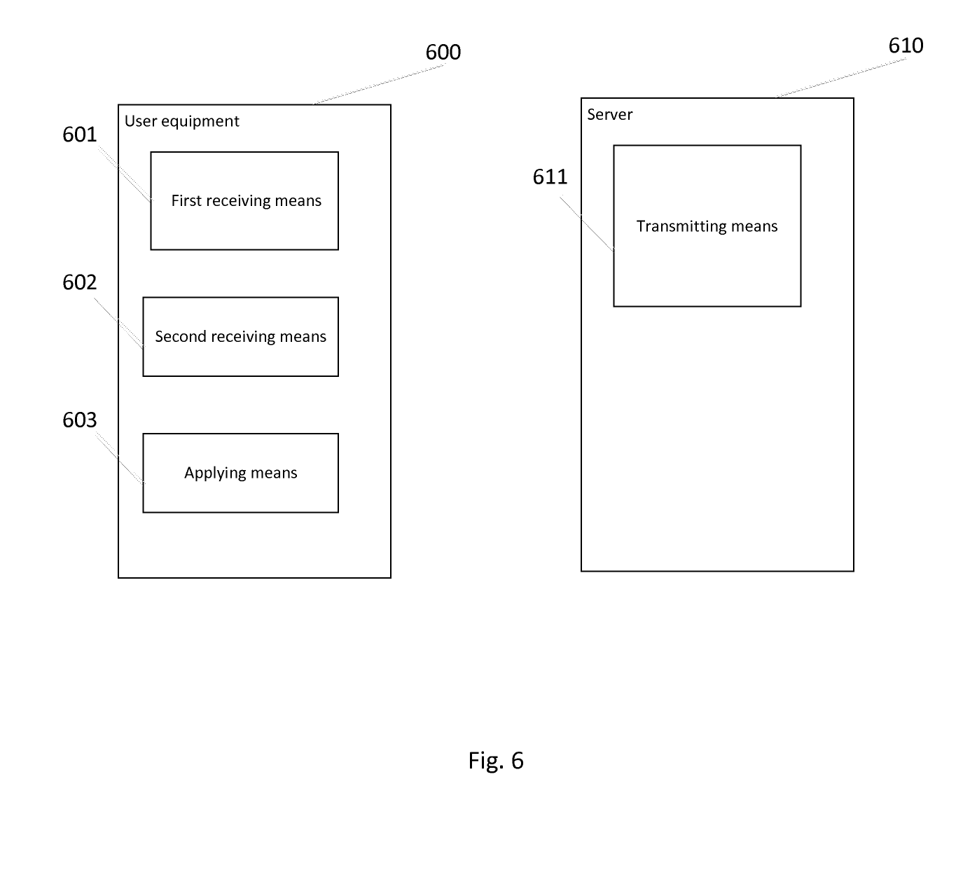

FIG. 6 illustrates a system of apparatuses according to embodiments of the invention. The system may comprise a user equipment 600 and a server 610.

The user equipment 600 may comprise first receiving means 601 for receiving offloading assistance information from a network element of a first network. User equipment 600 may also comprise second receiving means 602 for receiving at least one offloading related policy for offloading traffic to at least one second network. The offloading related policy may comprise a policy validity criterion that may take the offloading assistance information into account. User equipment 600 may also comprise applying means 603 for applying the offloading related policy in user equipment 600 if the policy validity criterion is met.

Server 610 may comprise a transmitting means 611 for transmitting the at least one offloading related policy for offloading traffic from the first network to the at least one second network to the user equipment 600.

The described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
receiving, by a user equipment, offloading assistance information from a network element of a first network;
receiving, by the user equipment, at least one offloading related policy for offloading traffic to at least one second network, wherein the offloading related policy comprises a policy validity criterion that takes the offloading assistance information into account; and
applying the offloading related policy in the user equipment if the policy validity criterion is met.

2. The method according to claim 1, wherein the offloading assistance information comprises at least one of
load information of the first network; and
an indication of whether a load of the first network is high, normal, or low.

3. The method according to claim 1, wherein the offloading related policy comprises identification information of the at least one second network and related offloading priority information.

4. The method according to claim 1, wherein at least two offloading related policies are received and wherein only one of the received offloading related policies is applied at a time.

5. The method according to claim 1, wherein the network element of the first network is a base station.

6. The method according to claim 1, wherein the offloading related policy for offloading traffic from the first network to the at least one second network is received from a server.

7. The method according to claim 1, wherein the first network is an access network and the second network is a Wireless Local Area Network.

8. An apparatus, comprising at least one processor and at least one memory comprising computer program code, the at least one memory and the computer program code are configured to, with the at least one processor, cause the apparatus at least to
receive offloading assistance information from a network element of a first network; and
receive at least one offloading related policy for offloading traffic to at least one second network, wherein the offloading related policy comprises a policy validity criterion that takes the offloading assistance information into account; and
apply the offloading related policy in the apparatus if the policy validity criterion is met.

9. The apparatus according to claim 8, wherein the offloading assistance information comprises at least one of
load information of the first network; and
an indication of whether a load of the first network is high, normal, or low.

10. The apparatus according to claim 8, wherein the offloading related policy comprises identification information of the at least one second network and related offloading priority information.

11. The apparatus according to claim 8, wherein at least two offloading related policies are received and wherein only one of the received offloading related policies is applied at a time.

12. The apparatus according to claim 8, wherein the network element of the first network is a base station.

13. The apparatus according to claim 8, wherein the offloading related policy for offloading traffic from the first network to the at least one second network is received from a server.

14. The apparatus according to claim 8, wherein the first network is an access network and the second network is a Wireless Local Area Network.

15. The apparatus according to claim 8, wherein the apparatus is a user equipment.

16. A computer program product, embodied on a non-transitory computer readable medium, the computer program product configured to control a processor to perform a process according to claim 1.

17. A method, comprising:
transmitting, by a network element, a policy for offloading traffic from a first network to at least one second network to a user equipment, wherein the policy for offloading traffic comprises a policy validity criterion taking offloading assistance information from the first network into account.

18. The method according to claim 17, wherein the offloading related policy comprises identification information of the at least one second network and related offloading priority information.

19. The method according to claim 17, wherein the transmitting comprising transmitting at least two policies for offloading traffic, wherein the policy validity criterion of each policy are exclusive and allow the applying of only one policy at a time.

20. The method according to claim 17, wherein the network element comprises a server.

21. The method according to claim 17, wherein the first network is an access network and the second network is a Wireless Local Area Network.

22. An apparatus, comprising at least one processor and at least one memory comprising computer program code, the at least one memory and the computer program code are configured to, with the at least one processor, cause the apparatus at least to
transmit a policy for offloading traffic from a first network to at least one second network to a user equipment, wherein the policy for offloading traffic comprises a policy validity criterion taking offloading assistance information from the first network into account.

23. The apparatus according to claim 22, wherein the offloading related policy comprises identification information of the at least one second network and related offloading priority information.

24. The apparatus according to claim 22, wherein the at least one memory and the computer program code are further configured to cause the apparatus to transmit at least two policies for offloading traffic, wherein the policy validity criterion of each policy are exclusive and allow the applying of only one policy at a time.

25. The apparatus according to claim 22, wherein the apparatus comprises a server.

26. The apparatus according to claim 22, wherein the first network is an access network and the second network is a Wireless Local Area Network.

27. A computer program product, embodied on a non-transitory computer readable medium, the computer program product configured to control a processor to perform a process according to claim 17.
